(19) United States
(12) Patent Application Publication
(10) Pub. No.: US 2009/0239618 A1
(43) Pub. Date: Sep. 24, 2009

(54) Slot Machine

(75) Inventor: Kazuo OKADA, Tokyo (JP)

Correspondence Address: NDQ&M WATCHSTONE LLP, 1300 EYE STREET, NW, SUITE 1000 WEST TOWER, WASHINGTON, DC, 20005, US

(73) Assignee: ARUZE GAMING AMERICA INC., Las Vegas, NV (US)

(21) Appl. No.: 12/206,238

(22) Filed: Sep. 8, 2008

Related U.S. Application Data
(60) Provisional application No. 61/038,951, filed on Mar. 24, 2008.

(51) Int. Cl. A63F 9/24; A63F 13/00

(52) U.S. Cl. 463/20

(57) ABSTRACT

A slot machine includes a display device having a symbol display region for displaying plural types of symbols; a memory for storing data relating to a plurality of display images for displaying a remaining number of frames to arrange symbols displayed on the display region, in a predetermined combination on a winning line; and a controller for controlling the display device and the memory The controller is programmed to: rearrange the plural types of symbols in the symbol display region; detect the remaining number of frames to rearrange the symbols making up a winning combination on the winning line at the time of the rearrangement; read out of the memory, the data relating to the display image corresponding to the detected remaining number of frames, in the case where the arranged symbols do not form the predetermined combination on the winning line; and display on a predetermined display region the remaining number of frames to arrange the symbols displayed on the display region, in the predetermined combination on the winning line.

### CROSS-REFERENCE TO RELATED APPLICATIONS

This application claims priority of U.S. Provisional Application No. 61/038,951 filed on Mar. 24, 2008. The contents of this application are incorporated herein by reference in their entirety.

### BACKGROUND OF THE INVENTION

1. Field of the Invention

The present invention relates to a slot machine.

2. Description of the Related Art

In a conventional slot machine, when a player inserts a game medium, such as a coin and a bill, in an insertion slot of a slot machine and presses a SPIN button, a display provided on a front face of a cabinet displays a plurality of symbols in a scrolling manner.

Then, scrolling of each of the symbols automatically stops. As such a slot machine, for example, as disclosed in U.S. Pat. No. 6,093,102, a slot machine exists which employs a concept of a winning line. In this concept, in the case where a combination of symbols rearranged on a winning line is a predetermined winning combination, a predetermined number of game media are paid out.

In addition, as such a slot machine, for example, as disclosed in each of U.S. Pat. No. 6,604,999 and U.S. Patent Publication No. 2002/0065124, a slot machine exists which provides two types of payouts, including a payout determined by a combination of symbols rearranged on a winning line and a payout determined by a number of displayed scatter symbols.

With the aforementioned slot machine of a related art, however, players are allowed to have expectations only for random payout based on a combination of plural types of symbols that have been randomly arranged in the display device. Accordingly, a need exists for the advent of a slot machine which can offer new entertainability.

The present invention has been made in view of the above-described circumstance. It is an object of the present invention to provide a novel slot machine by enhancing entertainability associated with rearrangement of the symbols.

### SUMMARY OF THE INVENTION

A first aspect of the present invention is a slot machine including: a display device having a symbol display region for displaying plural types of symbols; a memory for storing data relating to a plurality of display images used for displaying a remaining number of frames to arrange symbols displayed on the display region, in a predetermined combination on a winning line; and a controller for controlling the display device and the memory. The controller is programmed to: (a) execute a basic game; (b) rearrange by displaying in a scrolling manner, the plural types of symbols in the symbol display region during the basic game; (c) detect the remaining number of frames to rearrange the symbols making up a winning combination on the winning line at the time of the rearrangement of the itemized (b); (d) award a payout in the case where the symbols displayed on the symbol display region are arranged in the predetermined combination on the winning line; (e) read out of the memory, the data relating to the display image corresponding to the remaining number of frames detected in the itemized (c), in the case where the symbols displayed on the symbol display region are not arranged in the predetermined combination on the winning line; and (f) display on a predetermined display region, the remaining number of frames to arrange the symbols displayed on the display region, in the predetermined combination on the winning line, based on the read data relating to the display image.

According to the first aspect, in the case where the symbols does not form the predetermined combination on the winning line, the display image corresponding to the remaining number of frames is displayed. For example, a payout is to be awarded on condition that a combination of “WILD-WILD-WILD” is formed upon rearrangement of the symbols. In this case, when a combination of “WILD-WILD-ANY” is formed, i.e., when rotation of the reels is stopped with the last symbol “WILD” positioned behind by two frames, the display image of “two more frames to win WILD prize” is displayed. Therefore, the slot machine can be improved in its entertainability associated with symbol rearrangement.

A second aspect of the present invention is a slot machine constituted as set forth below. In the first aspect, the controller, in the itemized (e), reads out of the memory, the data relating to the display image corresponding to the remaining number of frames detected in the itemized (c), in the case where the combination is a specific combination from among the plural types of combinations, and then executes the itemized (f).

According to the second aspect, in the case where the symbols form the predetermined combination on the winning line, the display image corresponding to the remaining number of frames is displayed. For example, in the case where a combination of “WILD-WILD-ANY” is formed upon rearrangement of the symbols, the display image corresponding to the remaining number of frames is displayed. Therefore, the slot machine can be improved in its entertainability associated with symbol rearrangement.

A third aspect of the present invention is a slot machine constituted as set forth below. In the first or second aspect, the slot machine further includes an input device for inputting a user ID. The controller is programmed to: (g) output based on the user ID input through the input device, a control signal for making a computer on a network authenticate the user ID; and (h) receive from the computer on the network, a process signal corresponding to the control signal; and the controller executes the processes itemized (c), (e), and (f) based on an authentication result of the user ID in accordance with the received process signal.

According to the third aspect, in the case where the symbols form the predetermined combination on the winning line, the display image corresponding to the remaining number of frames is displayed based on the authentication result of the input user ID. Therefore, the slot machine can be improved in its entertainability associated with symbol rearrangement.

A fourth aspect of the present invention is a slot machine including: a display device having a symbol display region for displaying plural types of symbols; a memory for storing data relating to a plurality of display images used for displaying a remaining number of frames to arrange symbols displayed on the display region, in a predetermined combination on a winning line; and a controller for controlling the display device and the memory. The controller is programmed to: (a) execute a basic game; (b) rearrange by displaying in a scrolling manner, the plural types of symbols in the symbol display region during the basic game; (c) detect the remaining number of frames to rearrange the symbols making up a winning combination on the winning line at the time of the rearrangement of the itemized (b); (d) award a payout in the case where the symbols displayed on the symbol display region are arranged in the predetermined combination on the winning line; (e) read out of the memory, the data relating to the display image corresponding to the remaining number of frames detected in the itemized (c), in the case where the symbols displayed on the symbol display region are arranged in a specific combination from among plural types of combinations; and (f) display on a predetermined display region, the remaining number of frames to arrange the symbols displayed on the display region, in the predetermined combination on the winning line, based on the read data relating to the display image.

According to the fourth aspect, in the case where the symbols form the predetermined combination on the winning line, the display image corresponding to the remaining number of frames is displayed. For example, in the case where a combination of “WILD-WILD-ANY” is formed upon rearrangement of the symbols, the display image corresponding to the remaining number of frames is displayed. Therefore, the slot machine can be improved in its entertainability associated with symbol rearrangement

A fifth aspect of the present invention is a slot machine constituted as set forth below. In the fourth aspect, the slot machine further includes an input device for inputting a user ID. The controller is programmed to: (g) output based on the user ID input through the input device, a control signal for making a computer on a network authenticate the user ID; and (h) receive from the computer on the network, a process signal corresponding to the control signal. The controller executes the processes itemized (c), (e), and (f) based on an authentication result of the user ID in accordance with the received process signal.

According to the fifth aspect, in the case where the symbols form the predetermined combination on the winning line, the display image corresponding to the remaining number of frames is displayed based on the authentication result of the input user ID. Therefore, the slot machine can be improved in its entertainability associated with symbol rearrangement.

A sixth aspect of the present invention is a slot machine including: a display device having a symbol display region for displaying plural types of symbols; a memory for storing data relating to a plurality of display images used for displaying a remaining number of frames to arrange symbols displayed on the display region, in a predetermined combination on a winning line; a input device for inputting a user ID; and a controller for controlling the display device, the memory, and the input device. The controller is programmed to: (a) output based on the user ID input through the input device, a control signal for making a computer on a network authenticate the user ID; and (b) receive from the computer on the network, a process signal corresponding to the control signal; (c) execute a basic game; (d) rearrange by displaying in a scrolling manner, the plural types of symbols in the symbol display region during the basic game; (e) detect the remaining number of frames to rearrange the symbols making up a winning combination on the winning line, based on an authentication result of the user ID in accordance with the received process signal at the time of the rearrangement of the itemized (d); (f) award a payout in the case where the symbols displayed on the symbol display region are arranged in the predetermined combination on the winning line; (g) read out of the memory, the data relating to the display image corresponding to the remaining number of frames detected in the itemized (e) based on the authentication result of the user ID in accordance with the received process signal, in the case where the symbols displayed on the symbol display region are arranged in a specific combination from among the plural types of combinations; and (h) display on a predetermined display region, the remaining number of frames to arrange the symbols displayed on the display region, in the predetermined combination on the winning line, based on the read data relating to the display image, based on the authentication result of the user ID in accordance with the received process signal.

According to the sixth aspect, in the case where the symbols form the predetermined combination on the winning line, the display image corresponding to the remaining number of frames is displayed based on the authentication result of the input user ID. For example, a payout is to be awarded on condition that a combination of “WILD-WILD-WILD” is formed upon rearrangement of the symbols. In this case, when a combination of “WILD-WILD-ANY” is formed, i.e., when rotation of the reels is stopped with the last symbol “WILD” positioned behind by two frames, the display image of “two more frames to win WILD prize” is displayed. Therefore, the slot machine can be improved in its entertainability associated with symbol rearrangement

### BRIEF DESCRIPTION OF THE DRAWINGS

FIG. 1 is a view schematically showing symbol rearrangement according to a first embodiment;

FIG. 2 is a perspective view schematically showing a slot machine according to the first embodiment;

FIG. 3 is a perspective view schematically showing reels according to the first embodiment;

FIG. 4 is a view showing an internal construction of the slot machine shown in FIG. 2;

FIG. 5 is a view showing an internal construction of the reels shown in FIG. 4;

FIG. 6 is a view showing one example of symbols arranged on the reels according to the first embodiment;

FIG. 7 is a view showing a correspondence relationship between each of various symbols and payouts;

FIG. 8 is a view showing one example of a data table of display images according to the first embodiment;

FIG. 9A is a view showing an exemplary image displayed in the slot machine shown in FIG. 2;

FIG. 9B is a view showing an exemplary image displayed in the slot machine shown in FIG. 2;

FIG. 10A is a view showing an exemplary image displayed in the slot machine shown in FIG. 2;

FIG. 10B is a view showing an exemplary image displayed in the slot machine shown in FIG. 2;

FIG. 11 is a flowchart showing a subroutine of the main process;

FIG. 12 is a flowchart showing a subroutine of a game execution process according to the first embodiment;

FIG. 13 is a flowchart showing a subroutine of symbol rearrangement process according to the first embodiment;

FIG. 14 is a flowchart showing a subroutine of a free game execution process according to the first embodiment;

FIG. 15 is a flowchart showing a subroutine of a jackpot bonus game execution process according to the first embodiment of the present invention;

FIG. 16A is a view showing an exemplary image displayed in the slot machine shown in FIG. 2 according to a second embodiment of the present invention;

FIG. 16B is a view showing an exemplary image displayed in the slot machine shown in FIG. 2 according to the second embodiment; and

FIG. 17 is a flowchart showing a subroutine of a symbol rearrangement process according to the second embodiment.

### DESCRIPTION OF THE PREFERRED EMBODIMENTS

First, a slot machine 10 according to a first embodiment will be described in detail with reference to the drawings. Here, the slot machine according to the first embodiment described below is a so-called hybrid type slot machine, which has a transparent liquid crystal panel allocated in front of a plurality of mechanical reels supported in a rotatable manner, and executes a game by displaying images of various symbols drawn on an outer peripheral surface of the mechanical reels through the transparent liquid crystal panel.

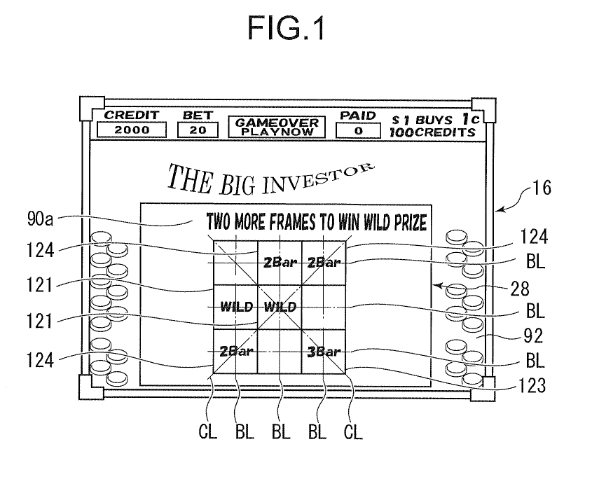

FIG. 1 is a view showing one example of rearranged symbols according to the first embodiment. The slot machine 10 according to the present invention executes any one of three types of gaming modes including a basic game, a free game, and a progressive bonus game. The basic game is executed upon consuming a gaming value corresponding to the amount bet by a player. The free game is executed without consuming a gaming value. The progressive bonus game is executed when a jackpot value reaches a predetermined progressive value. While the slot machine 10 is of a stand-alone type, which is not connected to a network, the present invention is also applicable to a networked slot machine.

As shown in FIG. 1, in the symbol display area 28, six basic lines BL are set in the column and row directions. In the embodiments of the present invention, the basic line shall mean a winning line other than a cross line. Furthermore, two cross lines CL are set in directions that obliquely cross the symbol display region 28. The eight winning lines in the embodiments of the present invention contain the basic lines BL and the cross lines CL.

In the first embodiment of the present invention, any combination of symbols “WILD” 121, “7” 122, “3Bar” 123, “2Bar” 124, “1Bar” 125, and “blank” 126 is rearranged in the symbol display region 28. A payout is awarded in the case where a combination of rearranged symbols is a predetermined one on the winning line.

As shown in FIG. 1, any combination of symbols “WILD” 121, “7” 122, “3Bar” 123, “2Bar” 124, “1Bar” 125, and “blank” 126 is rearranged in the symbol display region 28. Furthermore, the payout is awarded in the case where symbols displayed on the symbol display region 28 are arranged in a predetermined combination on the winning line. In the case where the combination is not a predetermined one, the remaining number of frames to form the predetermined combination is displayed. In this case, a combination of “WILD-WILD-blank” is rearranged on the winning line of the basic line BL, in which the rearranged symbols do not form the predetermined combination. Therefore, a remaining frame number display image 90a of “two more frames to win WILD prize” is displayed, which indicates that a reel needs scrolling down by two more frames to form a combination of “WILD-WILD-WILD”.

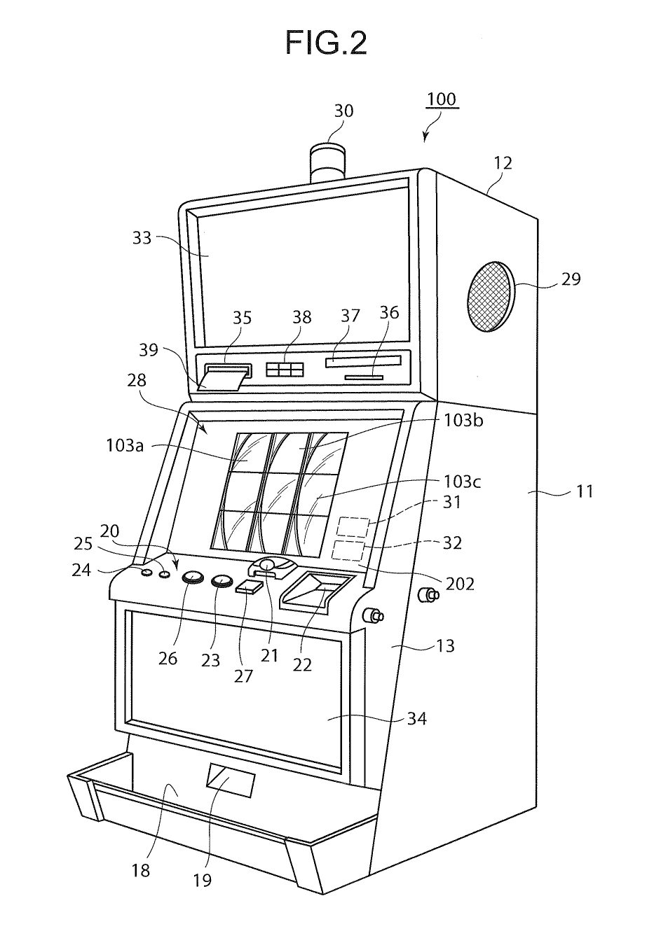

FIG. 2 is a view schematically depicting a frame format of an appearance of the slot machine according to the first embodiment. The gaming media used in the slot machine 10 include coins, bills, or electronic value information equivalent thereto. In the present invention, however, the gaming media are not limitative thereto in particular, and can include medals, tokens, electric money, and tickets, for example. The above tickets are not limitative in particular, and can include barcode-attached tickets or the like, as described later, for example.

The slot machine 10 is provided with a cabinet 11, a top box 12 installed on an upper side of the cabinet 11, and a main door 13 provided on a front surface of the cabinet 11.

The lower image display panel 16 serving as a display device is provided in front of the main door 13. The lower image display panel 16 is provided with a liquid crystal panel which displays various types of information or effect images relating to a game during the game.

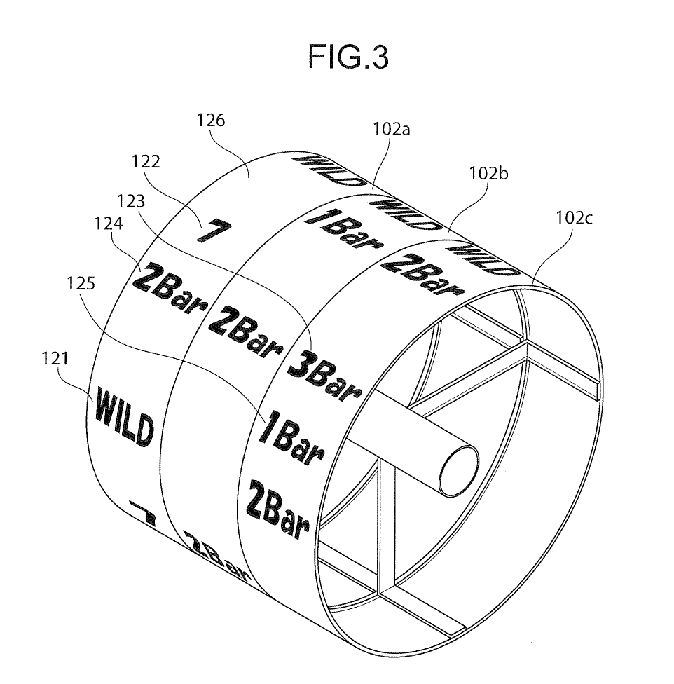

At a center of the lower image display panel 16, the symbol display region 28 for displaying symbols is provided. In the symbol display region 28, three reels 102a to 102c are rotatably provided, as shown in FIG. 3. A symbol line made up of the symbols “WILD” 121, “7” 122, “3Bar” 123, “2Bar” 124, and “1Bar” 125 is drawn on the outer peripheral surface of each of the reels 102a to 102c. When rotation of the reels 102a to 102c stops, any combination of symbols “WILD” 121, “7” 122, “3Bar” 123, “2Bar” 124, “1Bar” 125, and “blank” 126 is rearranged in the symbol display region 28.

The lower image display panel 16 is set with the winning lines containing the six basic lines BL and two cross lines CL. The six basic lines run in column and row directions of the symbol display region 28. The two cross lines run in an oblique direction across the symbol display region 28. The basic lines BL and the cross lines CL as winning lines define a combination of symbols.

A credit amount display unit 31 of the lower image display panel 16 displays the number of coins credited by way of an image. A payout amount display unit 32 displays by way of an image the number of coins to be paid when the predetermined combination of symbols are rearranged on the winning line.

Provided on a lower side of the lower image display panel 16 are a control panel 20 having a plurality of buttons 23 to 27 through which command regarding the process of the game will be input by a player, a coin receiving slot 21 for receiving coins into the cabinet 11, and a bill validator 22.

On the control panel 20, a start button 23, a change button 24, a cashout button 25, a 1-BET button 26, and a max-BET button 27 are provided. The start button 23 is intended for entering a command for starting the game. The change button 24 is intended for use in asking an attendant of the gaming facility for change. The cashout button 25 is intended for entering a command for paying the credited coins to a coin tray 18 through a coin payout exit 19.

The 1-BET button 26 is intended for entering a command for betting one coin among the credited coins on the game. The max-BET button 27 is intended for entering a command for betting on the game, the maximum number (50 in this embodiment) of coins that can be bet per game among the credited coins.

The bill validator 22 validates whether or not a bill is legitimate and accepts a legitimate bill into the cabinet 11. The bill validator 22 may be configured so that a barcode-attached ticket 39 described later is readable thereby. Provided on a lower front surface of the main door 13, that is, at a lower part of the control panel 20, is a berry glass 34 on which characters of the slot machine 10 and the like are depicted.

On a front surface of the top box 12, an upper image display panel 33 is provided. The upper image display panel 33 has a liquid crystal panel, which displays images for introducing the game contents or explaining game rules, for example.

Also, on the top box 12, a lamp 30 and a speaker 29 are provided. On a lower side of the upper image display panel 33, a ticket printer 35, a card reader 36, a data display 37, and a key pad 38 are provided. The ticket printer 35 prints on a ticket a barcode having encoded thereon data such as data and time, and the identification number of the slot machine 10. Further, this printer outputs the printed ticket as a barcode-attached ticket 39. A player causes another slot machine to read the bar-code-attached tickets 39, allowing the slot machine to perform games, or alternatively, allowing the exchange of bar-code-attached tickets 39 with bills or the like at a predetermined site of a game facility (for example, at the casher in a casino).

The card reader 36 reads data from and write data into a smart card. The smart card is to be owned by the player, which stores data for identifying the player or data regarding the log of games executed by the player, for example. The smart chard may store data corresponding to coins, bills, or a credit. As an alternative of a smart card, a magnetic stripe card may be employed. The data display 37 is made up of a fluorescent display and the like, and displays the data read by the card reader or the data input by the player through the key pad 38, for example. The key pad 38 inputs data and commands regarding the ticket issuance or the like.

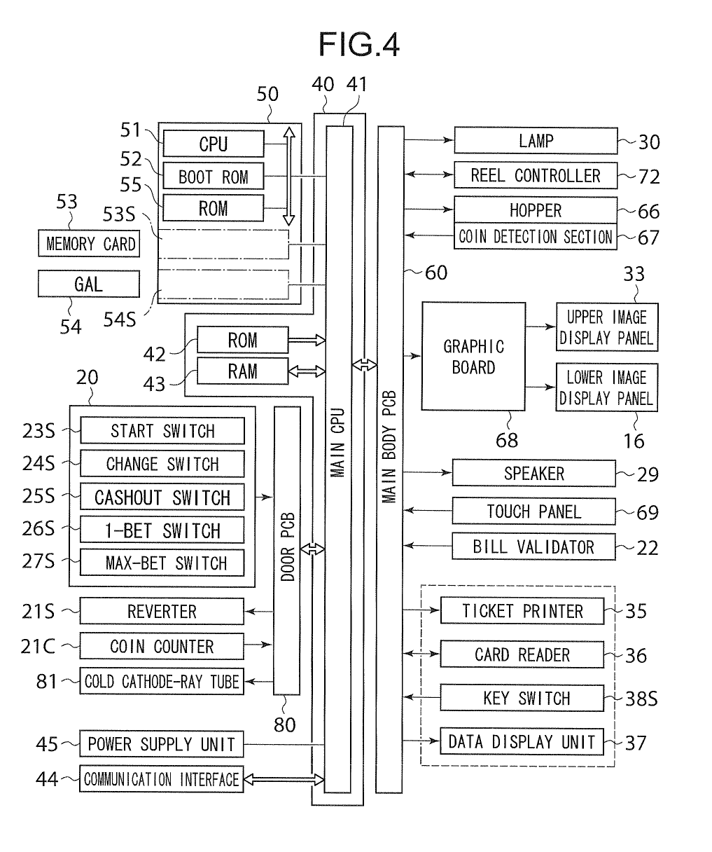

FIG. 4 is a block diagram depicting the internal construction of the slot machine shown in FIG. 2. A gaming board 50 includes: a CPU (Central Processing Unit) 51, a ROM (Read-only Memory) 55 and a boot ROM 52 interconnected by an internal bus; a card slot 53S corresponding to a memory card 53; and an IC socket 54S corresponding to a GAL (Generic Array Logic) 54.

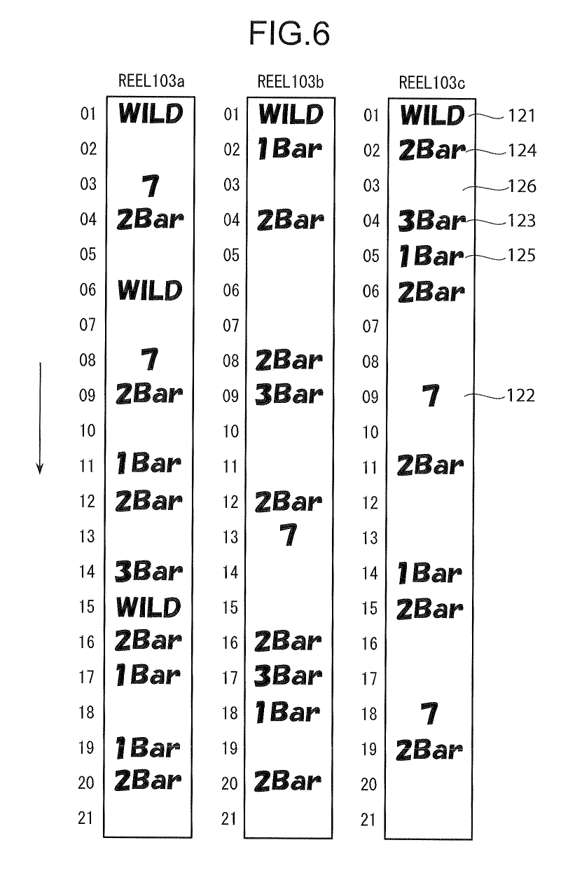

A memory card 53 is composed of a non-volatile memory, such as CompactFlash (registered trademark), and stores a game program. The game programs include a symbol selection program. The aforementioned symbol selection program is intended for determining the symbols to be rearranged in the symbol display region 28. The symbol selection program includes symbol weighing data corresponding to each of plural types of payout ratios (for example, 80%, 84%, and 88%). The symbol weighing data is indicative of the correspondence relationship between a code number of each of symbols (see FIG. 6) and one or more random number values which come under a predetermined numerical range (0 to 256), with respect to each of the reels 102a to 102c. The payout ratio is determined according to the payout-ratio setting data output from the GAL 54. The symbols to be stopped and displayed are determined depending upon the symbol weighing data corresponding to this payout ratio.

Also, the card slot 53S is configured to allow the memory card 53 to be inserted thereinto or ejected therefrom, and is connected to a motherboard 40 through an IDE pass. Accordingly, the memory card 53 can be ejected from the card slot 53S, other game programs and other game system programs can then be written into the memory card 53, and further, the memory card 53 can be inserted into the card slot 53S, thereby allowing the player to change the types and contents of games executed in the slot machine 10. The game program includes programs concerning a game progress. Furthermore, the game program includes image data or sound data to be output during the game. Furthermore, the game program includes image data or sound data to be output during the game. The image data include, for example, image data indicative of the symbol matrix.

The GAL 54 is a type of a PLD having a fixed OR array structure. The GAL 54 includes plural input ports and plural output ports. Where predetermined data is input to the input port, the GAL 54 outputs data corresponding to the aforementioned data from the output port. The data output from this output port is equivalent to the aforementioned payout-ratio setting data. Also, the IC socket 54S is configured to allow the GAL 54 to be inserted thereinto or ejected therefrom, and is connected to a motherboard 40 through PCI bus. Accordingly, the GAL can be replaced with the GAL 54 to change the payout-ratio setting data.

The CPU 51, the ROM 55, and the boot ROM 52 interconnected through the internal bus are connected to the motherboard 40 through the PCI bus. The PCI bus serves to transmit signals between the mother board 40 and the gaming board 50 and supply power from the mother board 40 to the gaming board 50.

The motherboard 40 is constructed using a general-purpose motherboard commercially available (a printed circuit board on which essential parts of a personal computer are mounted) and includes: a main CPU 41, a ROM (Read Only Memory) 42; a RAM (Random Access Memory) 43; and a communication interface 44. The main CPU 41 functions as a processor for controlling a display device according to the embodiment of the present invention.

The ROM 42 is made up of a memory device such as a flash memory and stores thereon a program such as BIOS (Basic Input/Output System) executed by the main CPU 41, and permanent data. When the BIOS is executed by the main CPU 41, processing of initializing predetermined peripheral devices is carried out and processing of capturing game programs and game system programs stored in the memory card 53 through the gaming board 50 is started. In the present invention, the contents of the ROM 42 may be rewritable or not.

The RAM 43 stores data and a program used when the main CPU 41 is activated. The RAM 43 can also store game programs. The RAM 43 further stores data concerning the credit amount, the number of coin-in or coin-out for one game, and the like.

Both a main body PCB (Printed Circuit Board) 60 and a door PCB 80, which will be described later, are connected to the motherboard 40 by USB. A power supply unit 45 is also connected to the motherboard 40.

Equipment and devices, which generate input signals to be input to the main CPU 41, and equipment and devices, operations of which are controlled by a control signal output from the main CPU 41, are connected to the body PCB 60 and the door PCB 80. The main CPU 41 executes the game programs stored in RAM 43, based upon an input signal that was input to the main CPU 41, thereby performing predetermined computational processing. Then, this CPU 41 stores results thereof into RAM 43; and transmits control signals to equipment and devices as control processing relative to the equipment and devices.

A lamp 30, a reel controller 72, a hopper 66, a coin detection section 67, a graphic board 68, a speaker 29, a touch panel 69, a bill validator 22, a ticket printer 35, a card reader 36, a key switch 38S and a data display 37, are connected to the body PCB60. The lamp 30 is lit up in a predetermined pattern, based upon a control signal output from the main CPU 41.

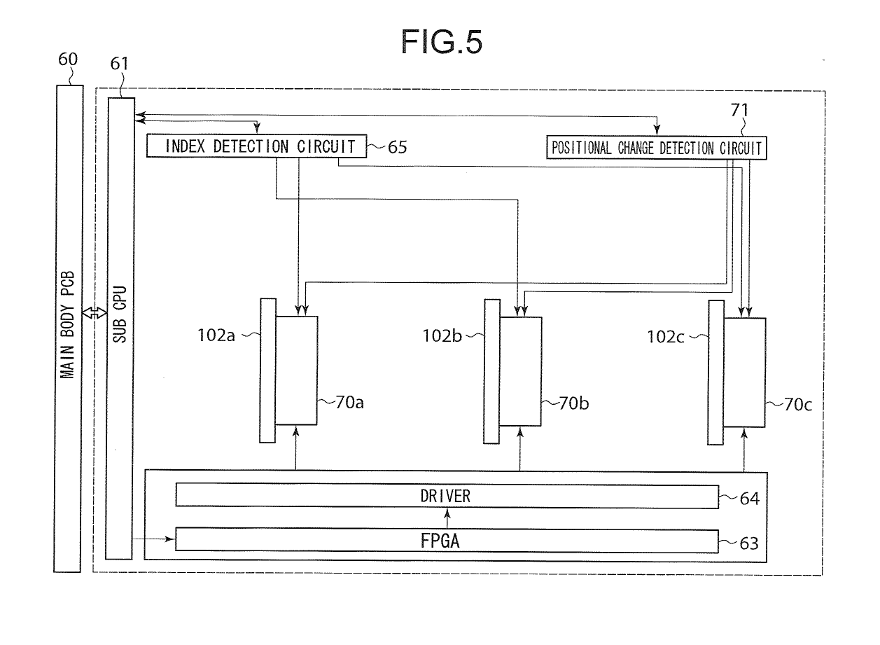

As shown in FIG. 5, a sub CPU 61 included in the reel controller 72 controls rotation and stop of the reels 102a to 102c. The sub CPU 61 is connected to a motor driving circuit 62 having an FPGA (Field Programmable Gate Array) 63 and a driver 64. The FPGA 63 is an electronic circuit such as a programmable LSI, and functions as a control circuit of a stepping motor 70. The driver 64 functions as an amplifier circuit for a pulse input to the stepping motors 70. The motor driving circuit 62 is connected to stepping motors 70a to 70c for rotating the reels 102a to 102c, respectively. The stepping motors 70 are stepping motors of one-two phase excitation mode.

The sub CPU 61 is connected to an index detection circuit 65 and a positional change detection circuit 71. The index detection circuit 65 detects positions (indices described later) of the rotating reels 102a to 102c, and further, can detect loss of synchronization of these reels 102a to 102c.

The positional change detection circuit 71 detects change in positions where the reels 102a to 102c are stopped after stop of rotation thereof. For example, the positional change detection circuit 71 detects change in positions where the reels 102a to 102c are stopped, in the case where a player forcibly changes the positions which actually do not result in a winning combination, to the positions corresponding to a winning combination. The positional change detection circuit 71 is constituted so as to detect change in the stop positions of the reels 102a to 102c by detecting, for example, fins (not shown) mounted at predetermined intervals to an inner part of the reels 102a to 102c.

The hopper 66 is installed in the cabinet 11. This hopper pays out a predetermined number of coins from a coin payout exit 19 to a coin tray 18, based upon a control signal output from the main CPU 41. A coin detection section 67 is installed inside the coin payout exit 19. This detection section outputs an input signal to the main CPU 41 at the time of detecting that a predetermined number of coins have been paid out from the coin payout exit 19.

The graphic board 68 performs control, based upon a control signal output from the main CPU 41, images to be displayed on the upper image display panel 33 and the lower image display panel 16. The credit amount display section 31 (see FIG. 2) on the lower image display panel 16 displays the number of credits stored in the RAM43. Further, the payout amount display section 32 (see FIG. 2) on the lower image display panel 16 displays the number of coins to be paid out. The graphic board 68 is equipped with: a VDP (Video Display Processor), which generates image data based upon a control signal output from the main CPU 41; and a video RAM, which temporarily stores image data generated by the VDP or the like. The image data used in generating image data with VDP is contained in the game program read from the memory card 53 and stored in the RAM 43.

The bill validator 22 validates whether or not a bill is legitimate and accepts a legitimate bill into the cabinet 11. The bill validator 22, upon accepting a legitimate bill, outputs an input signal to the main CPU 41 based on the bill amount. The main CPU 41 stores in the RAM 43 the credit amount corresponding to the bill amount transmitted by the input signal.

Based on a control signal output from the main CPU 41, the ticket printer 35 prints on a ticket a barcode having encoded thereon data such as the credit amount, data and time, and the identification number of the slot machine 10 stored in the RAM 43. Further, this printer outputs the printed ticket as a barcode-attached ticket 39. The card reader 36 transmits to the main CPU 41, the data read from the smart card, and writes the read data onto the smart card, based upon a control signal from the main CPU 41. The key switch 38S is provided on the key pad 38, and outputs a predetermined input signal to the main CPU 41 when a player operates the key pad 38. The data display 37 displays, based upon a control signal output from the main CPU 41, the data read by the card reader 36 and the data input by a player through the key pad 38.

The control panel 20, a reverter 21S, a coin counter 21C, and a cold cathode tube 81 are connected to the door PCB 80. The control panel 20 is provided with: a start switch 23S corresponding to the start button 23; a change switch 24S corresponding to the change button 24; a cashout switch 25S corresponding to the cashout button 25; a 1-BET switch 26S corresponding to the 1-BET button 26; and the MAX-BET switch 27S corresponding to the MAX-BET button 27. When the player operates the buttons 23 to 27, the corresponding switches 23S to 27S output input signals to the main CPU 41, respectively.

The coin counter 21C is provided inside the coin receiving slot 21, and validates whether or not a legitimate coin is inserted by a player into the coin receiving slot 21. Those other than the legitimate coins are discharged from the coin payout exit 19. The coin counter 21C outputs an input signal to the main CPU 41 when a legitimate coin is detected.

The reverter 21S operates based on a control signal output from the main CPU 41 and distributes coins recognized as being legitimate by the coin counter 21C into a cash box (not shown) or the hopper 66 which is arranged in the slot machine 10. Specifically, when the hopper 66 is filled with coins, the reverter 21S distributes legitimate coins into the hopper 21S. On the other hand, when the hopper 66 is not filled with coins, legitimate coins are distributed into the hopper 66. A cold cathode tube 81 functions as a backlight installed on a rear face side of each of the lower image display panel 16 and the upper image display panel 33, and is lit up based on a control signal output from the main CPU 41.

FIG. 6 is a view showing one example of symbols arranged on the reels according to the first embodiment. As shown in FIG. 6, a symbol line made up of the 21 symbols in plural types that are arranged on the outer peripheral surface of each of the reels 102a to 102c. The symbols are each assigned with a code number and are stored as a data table in the ROM 42 (see FIG. 4). The symbol line made up of the symbols “WILD” 121, “7” 122, “3Bar” 123, “2Bar” 124, and “1Bar” 125 is drawn on the outer peripheral surface of each of the reels 102a to 102c. The reels 102a to 102c are rotatably driven in a manner such that the symbol lines are shifted in a direction of an arrow in FIG. 6.

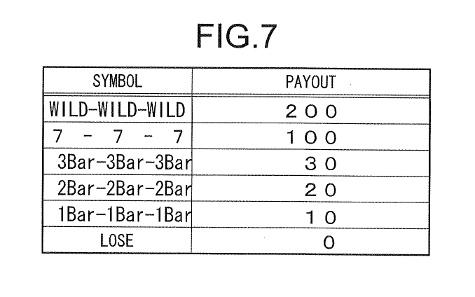

FIG. 7 is a view showing a correspondence relationship between each of various symbols and payouts. As shown in FIG. 6, where a predetermined symbol is rearranged on a winning line on which the player has bet, payout is determined based on a winning combination. The payout is determined in the case where symbols form any of winning combinations “WILD-WILD-WILD”, “7-7-7”, “3Bar-3Bar-3Bar”, and “2Bar-2Bar-2Bar”, “1Bar-1Bar-1Bar” on any of the basic lines BL and the cross lines CL as the winning lines set in the symbol display region 28. In the case of rearrangement of a combination of symbols “WILD-WILD-“WILD” on the winning line, the payout of “500” is obtained to thereby shift the game to the bonus game. The bonus game is offered after execution of the basic game or the free game. The bonus game is generally favorable to the player.

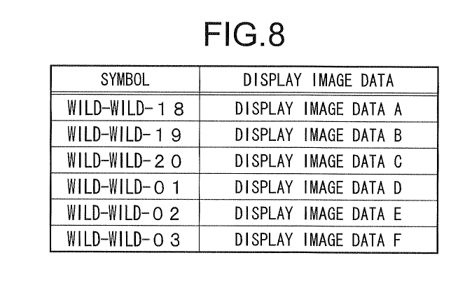

FIG. 8 is a view showing one example of a data table of display images according to the first embodiment. This data table of display images is stored in the ROM 42 and is used to display the remaining number of frames to arrange the symbols displayed on the symbol display region 28 in the predetermined combination on the winning line. As shown in FIG. 8, in the data table of display images, display image data is determined correspondingly to arrangement of the symbols displayed on the symbol display region 28. With respect to arrangement of the symbols displayed on the symbol display region 28, the display image data is determined based on a combination of the predetermined symbols arranged on the reels 102a, 102b, and code numbers (see FIG. 6) from 01 to 21, which are respectively assigned to the symbols arranged on the reel 102c. For example, rearrangement corresponding to a combination of “WILD-WILD-18” is such a case that a combination of “WILD-WILD-7” is displayed on the symbol display region 28, in which “7” is a symbol corresponding to the code number “18” arranged on the reel 102c.

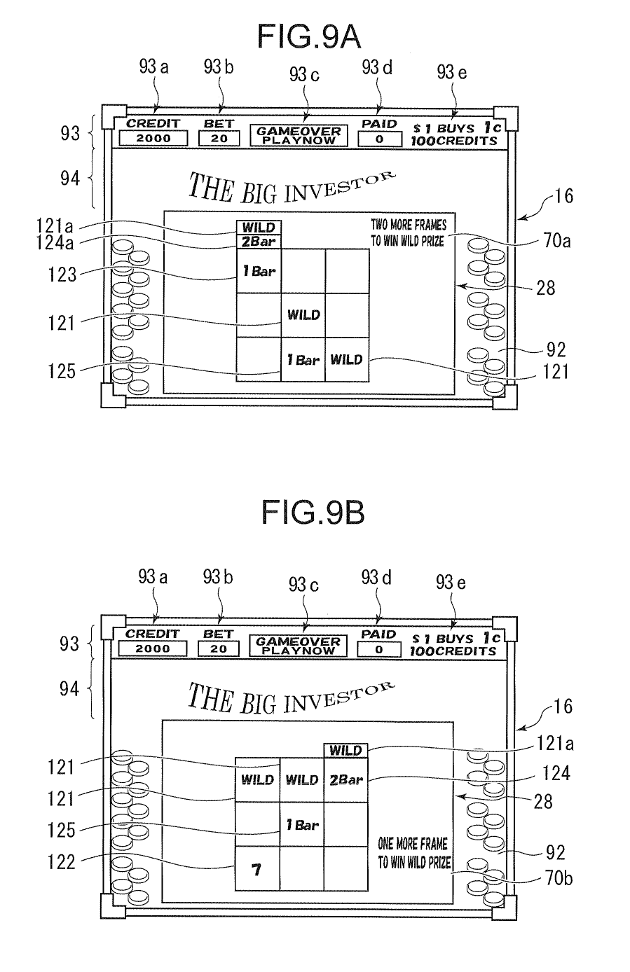

FIGS. 9A and 9B are views each showing an exemplary image displayed in the slot machine shown in FIG. 2, according to the first embodiment. As shown in FIG. 9A, the lower image display panel 16 is made up of a display region 92, an information display section 93, an effect image display section 94, and the like. The display area section 92 is for displaying a symbol display region 28. In addition, the information display section 93 is arranged above the display area section 92. This display section is made up of a credit amount display section 93a, a BET amount display section 93b, a character information display portion 93c, a PAID amount display section 93d, and a charge display section 93e.

The number of coins presently credited is displayed at the credit amount display section 93a while the number of coins bet in one game is displayed at the BET amount display section 93b. The character information indicative of a current status of the game is displayed at the character information display section 93c. The characters of “PLAYNOW” are displayed during the play of the game, whereas the characters of “GAMEOVER” are displayed during the intervals between the plays of the game. The number of coins that has been successfully obtained in one game is displayed at the PAID amount display section 93d, whereas a conversion value of the credit amount based on a predetermined charge is displayed at the charge display section. At the effect image display section 94, effect images in accordance with a type of the present slot game are displayed.

Any combination of the symbols “WILD” 121, “7” 122, “3Bar” 123, “2Bar” 124, “1Bar” 125, and “blank” 126 is rearranged in the symbol display region 28 displayed on the lower image display panel 14. In the case where the rearranged symbols form the predetermined combination on the winning line, the payout is awarded.

In this case, any combination of the symbols “WILD” 121, “7” 122, “3Bar” 123, “2Bar” 124, “1Bar” 125, and “blank” 126 is rearranged in the symbol display region 28. In the case where the symbols displayed on the symbol display region 28 are arranged in the predetermined combination on the winning line, the payout is awarded. In the case where the combination is not a predetermined one, the remaining number of frames to form the predetermined combination is displayed. In this case, a combination of “1Bar-WILD-WILD” is rearranged on the winning line of the cross line CL, in which the combination is not a predetermined one. Therefore, the remaining frame number display image 90a of “two more frames to win WILD prize” is displayed, which indicates that a reel needs scrolling down by two frames to form a combination of “WILD-WILD-WILD”, and a reel image “WILD” 121a indicative of a position of “WILD” and a reel image “2Bar” 124a are displayed.

As shown in FIG. 9B, any combination of symbols “WILD” 121, “7” 122, “3Bar” 123, “2Bar” 124, “1Bar” 125, and “blank” 126 is rearranged in the symbol display region 28. Furthermore, in the case where the symbols displayed on the symbol display region 28 are arranged in the predetermined combination on the winning line, the payout is awarded. In the case where the combination is not a predetermined one, the remaining number of frames to form the predetermined combination is displayed. In this case, a combination of “WILD-WILD-2Bar” is rearranged on the winning line of the basic line BL, in which the rearranged symbols do not form the predetermined combination. Therefore, the remaining frame number display image 70b of “one more frame to win WILD prize” is displayed, which indicates that the reel needs scrolling down by one frame to form a combination of “WILD-WILD-WILD”, and the reel image “WILD” 121a indicative of a position of “WILD” is displayed.

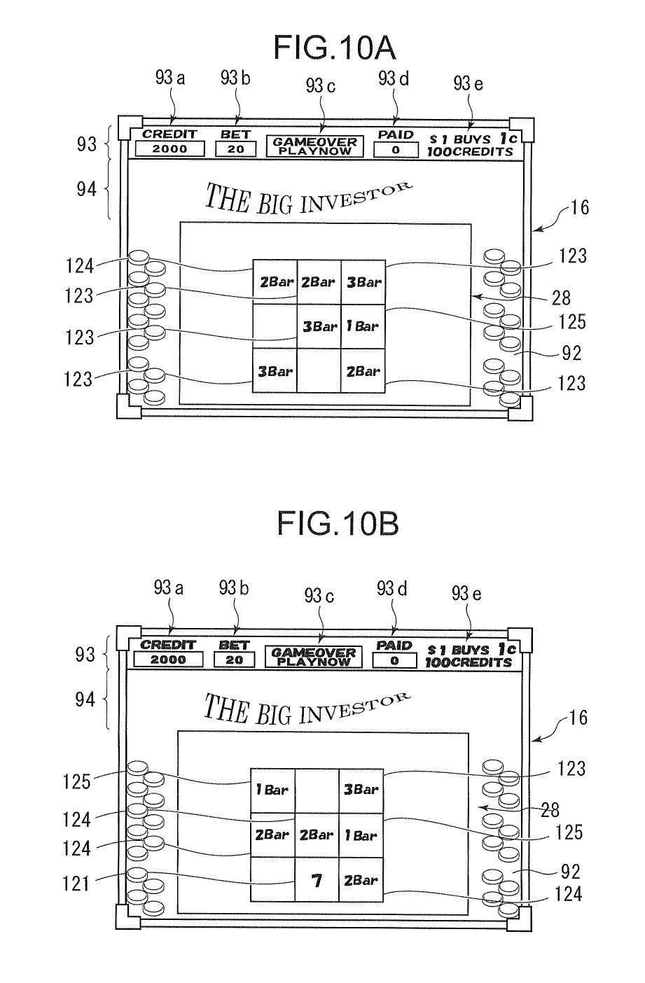

FIGS. 10A and 10B are views each showing an exemplary image displayed in the slot machine shown in FIG. 2. As shown in FIG. 10A, any combination of the symbols “WILD” 121, “7” 122, “3Bar” 123, “2Bar” 124, “1Bar” 125, and “blank” 126 is rearranged in the symbol display region 28. In the case where the symbols displayed on the symbol display region 28 are arranged in the predetermined combination on the winning line, the payout is awarded. In the case where the combination is not a predetermined one, the remaining number of frames to form the predetermined combination is displayed. In this case, a combination of “3Bar-3Bar-3Bar” is rearranged on the cross line CL, in which the rearranged symbols form the predetermined combination. Therefore, the payout is awarded based on the combination of “3Bar-3Ba-3Bar” without displaying the remaining number of frames to form the predetermined combination.

As shown in FIG. 10B, any combination of the symbols “WILD” 121, “7” 122, “3Bar” 123, “2Bar” 124, “1Bar” 125, and “blank” 126 is rearranged in the symbol display region 28. Furthermore, in the case where the symbols displayed on the symbol display region 28 are arranged in the predetermined combination on the winning line, the payout is awarded. In the case where the combination is not a predetermined one, the remaining number of frames to form the predetermined combination is displayed. In this case, a combination of “2Bar-2Bar-1Bar” is rearranged on the cross line CL, in which the rearranged symbols do not form the specific combination such as “WILD-WILD-ANY” or “7-7-ANY”. Therefore, the remaining number of frames to form the predetermined combination is not displayed and the payout is not awarded.

Next, a process executed in the slot machine 10 according to the first embodiment will be described in detail with reference to the accompanying drawings. The main CPU 41 reads out and executes a game program, thereby conducting the game.

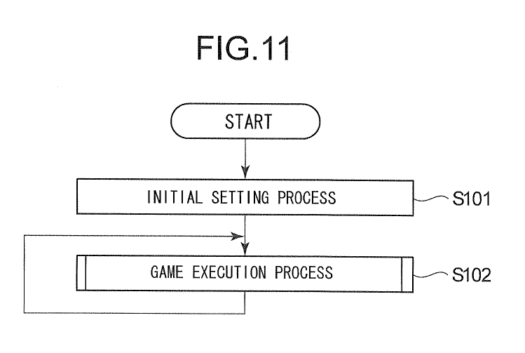

FIG. 11 is a flowchart showing a subroutine of the main process. In the main process, first, when a power switch is turned on (that is, when power is supplied), a motherboard 40 and a gaming board 50 are activated respectively, so that the CPU 51 executes an initial setting process (step S101). In this initial setting process, the main CPU 41 executes the BIOS stored in the ROM 42, decompresses, in the RAM 43, compressed data included in the BIOS, executes the BIOS decompressed in the RAM 43, and performs diagnosis and initialization of each of the peripheral devices. Further, the main CPU 41 writes game programs or the like from the ROM 42 into the RAM 43, and acquires payout-ratio setting data and country-identification information. The main CPU 41 also performs an authentication process for each program during execution of the initial setting process.

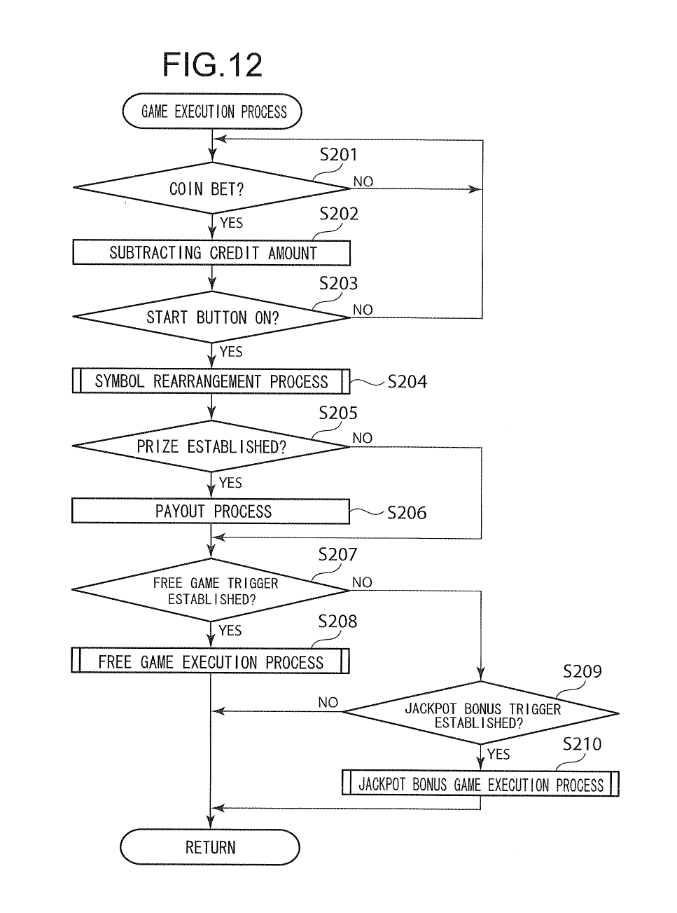

Next, the main CPU 41 performs a game execution process described later with reference to FIG. 12 (step S102). In this game execution process, the main CPU 41 sequentially reads and executes the game programs or the like from the ROM42. By performing this game execution process, the slot machine 10 executes the game according to the first embodiment. The game execution process is repeatedly performed while power is supplied to the slot machine 10.

FIG. 12 is a flowchart showing a subroutine of the game execution process invoked and performed at step S102 of the subroutine shown in FIG. 11. First, the main CPU 41 judges whether a coin has been bet or not (step S201). Specifically, the main CPU 41 judges whether or not an input signal has been received, the signal being output from the 1-BET switch 26S when the 1-BET button 26 is pressed, or alternatively, being output from the MAX-BET switch 27S when the MAX-BET button 27 is pressed. The main CPU 41 controls the current step to return to the process at step S201 upon judging that no coin has been bet (step S201: NO).

On the other hand, the main CPU 41 subtracts the number of bet coins from the credit amount stored in the RAM 43 (step S202) upon judging that a coin has been bet (step S201: YES). In the case where the number of bet coins is larger than the credit amount stored in the RAM 43, the main CPU 41 controls the current step to return to step S201 without performing the process for subtracting the number of bet coins from the credit amount stored in the RAM 43. In the case where the number of bet coins exceeds the upper limit (fifty coins in this embodiment) of coins that can be bet in one game, the main CPU 41 controls the process to shift to step S203 without performing the process for subtracting the number of bet coins from the credit amount stored in the RAM 43.

At step S203, the main CPU 41 judges whether or not the start button 23 has been set to ON (step S203). Specifically, the main CPU 41 judges whether or not an input signal has been received, the signal being output from the start switch 23S when the start button 23 is pushed. The main CPU 41 controls the step to return to step S201 upon judging that the start button 23 has not been set to ON (step S203: NO). Where the start button 23 has not been set to ON (for example, where an instruction has been input to terminate the game without setting the start button 23 to ON), the main CPU 41 cancels acceptance of a subtraction result at step S202.

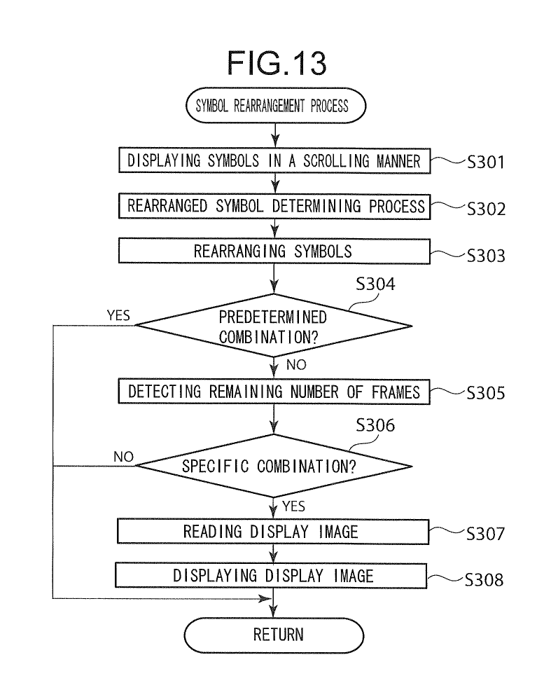

On the other hand, when the main CPU 41 judges that the start button 23 has been set to ON (step S203: YES), the main CPU 41 carries out symbol rearrangement process which will be described later with reference to FIG. 13 (step S204). Specifically, the CPU 41 executes the program stored in the RAM 43 and determines the symbols to be rearranged in the symbol display region 28 displayed on the lower image display panel 16. The symbols are determined from among the symbols, “WILD” 121, “7” 122, “3Bar” 123, “2Bar” 124, “1Bar” 125, and “blank” 126. This determination is based on the symbol weighting data and random numeric values sampled by sampling the random numeric values in a numerical range which comes under a predetermined range of random numeric values. The CPU 41 then rearranges the symbols in the symbol display region 28.

Next, the main CPU 41 judges whether a prize has been established or not (step S205). Specifically, the main CPU 41 judges whether or not the number of symbols of respective types rearranged in the symbol display region 28 is a winning number allowed to award any of payouts. The establishment of a prize shall mean that the symbols displayed on the symbol display region 28 are arranged in the predetermined combination (see FIG. 7).

Upon judging that the prize is established (step S205: YES), the main CPU 41 then executes a coin-payout process in accordance with the amount of bet and the number of coins set for the winning number (step S206). Where the coins are deposited, the main CPU 41 executes a process for adding the number of paid-out coins to the credit amount stored in the RAM 43. On the other hand, in the coin-payout process, the main CPU 41 transmits the control signal to the hopper 66 to pay out the predetermined amount of coins.

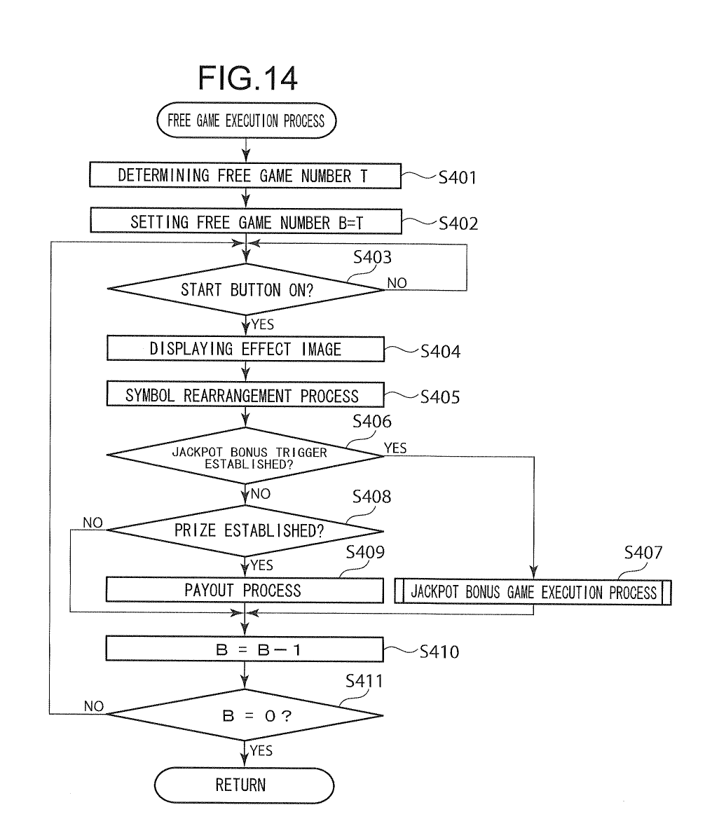

On the other hand, the main CPU 41 judges whether a free game trigger has been established or not (step S207) upon judging that the prize is not established (step S205: NO) or executing the process at step S206. Specifically, the main CPU 41 executes the program stored in the RAM 43 to sample the random numeric values in a numerical range which comes under a predetermined range of random numeric values, thereby judging whether or not the free game trigger condition has been satisfied based on the sampled random numeric values. Upon judging that the free game trigger is established (step S207: YES), the main CPU 41 executes a free game execution process described later with reference to FIG. 14 (step S208). In this free-game execution process, the main CPU 41 sequentially reads and executes the game programs or the like from the ROM 42 and performs the free-game execution process.

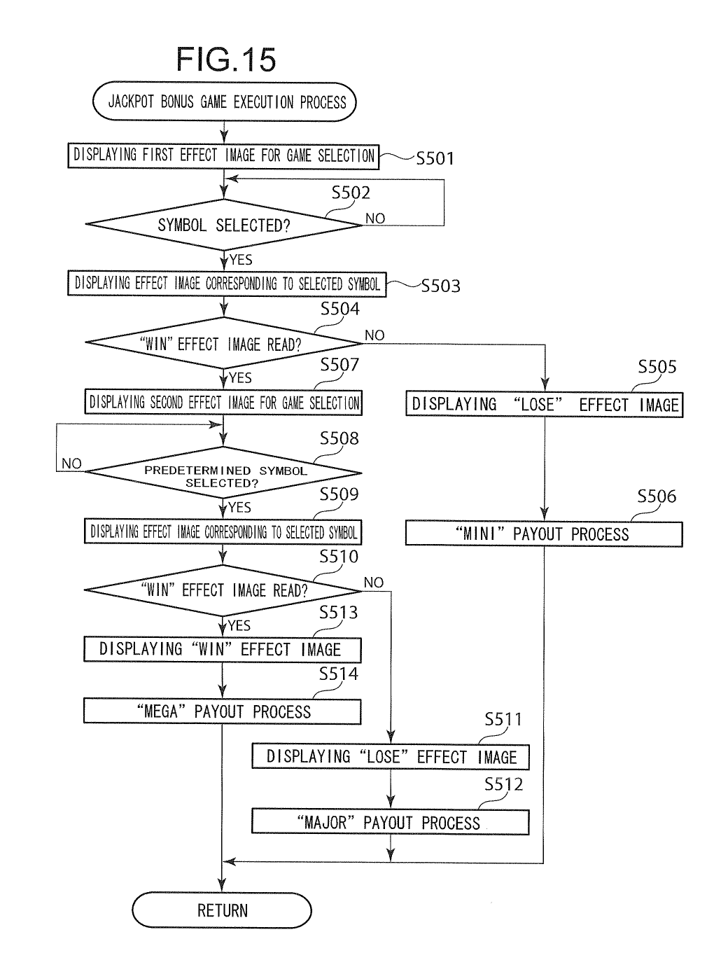

On the other hand, upon judging that the free game trigger has not been established (step S207: NO), the main CPU41 judges whether or not a jackpot bonus game trigger has been established (step S209). Specifically, the main CPU 41 executes the program stored in the RAM 43 to sample the random numeric values in a numerical range which comes under a predetermined range of random numeric values, thereby judging whether or not the jackpot bonus game trigger has been established based on the sampled random numeric values. Upon judging that the jackpot bonus game trigger has been established (step S209: YES), the main CPU 41 executes a jackpot bonus game execution process described later with reference to FIG. 15 (step S210). In this jackpot bonus game, the main CPU 41 sequentially reads and executes the game programs or the like from the ROM42 to execute the jackpot bonus game execution process.

The main CPU 41 terminates the game execution process upon judging that the jackpot bonus game trigger has not been established (step S209: NO) or when executing the process at step S208 and step S210.

FIG. 13 is a flowchart showing a subroutine of the symbol rearrangement process invoked and performed at step S204 of the subroutine shown in FIG. 12. First, the main CPU 41 displays the symbols in a scrolling manner (step S301). Specifically, the main CPU 41 starts rotation of the reels 102a to 102c. In this case, the six basic lines BL are set in the column and row directions in the symbol display region 28. Further, the two cross lines CL are set in directions that obliquely cross the symbol display region 28.

Next, the main CPU 41 determines the symbols to be rearranged (step S302). Specifically, with respect to symbols rearranged in the symbol display area 28, the main CPU 41 executes a program stored in the RAM 43 to sample a random number value from a numerical value range of a predetermined random number value range. On the basis of the sampled random number value and symbol weighing data, from among the symbols “WILD” 121, “7” 122, “3Bar” 123, “2Bar” 124, “1Bar” 125, and “blank” 126, the CPU 41 determines those to be rearranged in the symbol display area 28.

The main CPU 41 then rearranges the symbols (step S303). Specifically, the main CPU 41 stops rotation of the reels 102a to 102c so as to display, in a stopped state, the symbols determined at step S302, thereby rearranging the symbols.

Next, the main CPU 41 judges whether or not a combination is a predetermined one (step S304). Specifically, the main CPU 41 judges whether or not the symbols displayed on the symbol display region 28 are arranged in the predetermined combination allowed to award any of payouts. The main CPU 41 terminates the symbol rearrangement process upon judging that the combination is a predetermined one (step S304: YES).

On the other hand, upon judging that the combination is not a predetermined one (step S304: NO), the main CPU 41 detects the remaining number of frames (step S306). Specifically, when the symbols are rearranged in the symbol display region 28, the main CPU 41 detects the remaining number of frames to rearrange the symbols making up the winning combination on the winning line.

Next, the main CPU 41 judges whether or not the combination is a predetermined one (step S306). Specifically, the main CPU 41 judges whether or not any of combinations “WILD-WILD-18”, “WILD-WILD-19”, “WILD-WILD-20”, “WILD-WILD-01”, “WILD-WILD-02”, and “WILD-WILD-03” is formed (see FIG. 8). Upon judging that the combination is not a predetermined one (step S306: NO), the main CPU 41 terminates the symbol rearrangement process.

On the other hand, upon judging that the combination is a predetermined one (step S306: YES), the main CPU 41 reads out the display images (step S307). Specifically, the main CPU 41 reads out of the ROM 42, the display image data corresponding to the specific combination from among the plural types of display image data used to display the remaining number of frames to arrange the symbols in the predetermined combination, the symbols being displayed on the symbol display region 28.

The main CPU 41 then displays the display image (step S308). Specifically, the main CPU 41 displays the display image data read at step S307 on the lower image display panel 16. The main CPU 41 terminates the symbol rearrangement process when terminating this process.

FIG.14 is a flowchart showing a subroutine of a free-game execution process invoked and executed at step S208 of the subroutine shown in FIG. 12. First, the main CPU 41 determines a free-game number T as a number of times in executing the free game (step 401). Specifically, the main CPU 41 determines the free-game number T in accordance with a program stored in the RAM 43.

Next, the main CPU 41 performs a process for setting the free-game number B=T (step S402). Specifically, the main CPU 41 sets a remaining free-game number B=T in the storage area provided in the RAM 43, the area for storing the data indicative of the remaining free-game number B as the remaining number of times in executing the free game. A value of T is equal to the free-game number T determined at step S401.

The main CPU 41 then judges whether or not the start button 23 has been set to ON (step S403). Specifically, the main CPU 41 judges whether or not an input signal has been received, the signal being output from the start switch 23S when the start button 23 is pushed. The main CPU 41 controls the step to return to step S403 upon judging that the start button 23 has not been set to ON (step S403: NO).

Upon judging that the start button 23 has been set to ON (step S403: YES), on the other hand, the main CPU 41 performs a process for displaying an effect image (step S404). Specifically, the main CPU 41 displays a free-game-number display images corresponding to the free-game number on the upper image display panel 33.

Next, the main CPU 41 performs a symbol rearrangement process for the free game (step S405). Specifically, the CPU 41 executes the program stored in the RAM 43 and determines the symbols to be rearranged in the symbol display region 28, from among the symbols “WILD” 121, “7” 122, “3Bar” 123, “2Bar” 124, “1Bar” 125, and “blank” 126. This determination is based on the symbol weighting data and random numeric values sampled by sampling the random numeric values in a numerical range which comes under a predetermined range of random numeric values. The main CPU 41 then rearranges the symbols to be arranged in the symbol display region 28.

Next, the main CPU 41 judges whether or not a jackpot bonus trigger has been established (step S406). Specifically, the main CPU 41 executes the program stored in the RAM 43 to sample the random numeric values in a numerical range which comes under a predetermined range of random numeric values, thereby judging whether or not the jackpot bonus game trigger has been established based on the sampled random numeric values. Upon judging that the jackpot bonus game trigger has been established (step S406: NO), the main CPU 41 controls the process to shift to step S408.

On the other hand, upon judging that the jackpot bonus trigger has been established (step S406: YES), the main CPU 41 executes a jackpot bonus game execution process described later with reference to FIG. 15 (step S407). In this jackpot bonus game, the main CPU 41 sequentially reads and executes the game programs or the like from the ROM42 to execute the jackpot bonus game execution process.

Next, the main CPU 41 judges whether or not a prize has been established (step S408). Specifically, the main CPU 41 judges whether or not the number of symbols of respective types rearranged in the symbol display region 28 is a winning number allowed to award any of payouts. The establishment of a prize shall mean that the symbols displayed on the symbol display region 28 are arranged in the predetermined combination (see FIG. 7).

Thereafter, upon judging that the prize has been established (step S408: YES), the main CPU 41 performs a coin-payout process for paying out the coins of the number set for the winning number (step S409). Where the coins are deposited, the main CPU 41 executes a process for adding the number of paid-out coins to the credit amount stored in the RAM 43. On the other hand, in the coin-payout process, the main CPU 41 transmits the control signal to the hopper 66 to pay out the predetermined amount of coins.

On the other hand, upon judging that the prize has not been established (step S408: NO) or upon executing the processes at step S407 and step S409, the main CPU 41 sets the remaining free-game number B=B−1 (step S410). Specifically, the main CPU 41 sets B=B−1 at a value of the free-game number B stored in the RAM 43.

The main CPU 41 then judges whether or not a value of the remaining free-game number B is equal to zero (step S411). Specifically, the main CPU 41 judges whether or not a value of the remaining game number stored in the RAM43 is equal to zero. Upon judging that the value of the remaining free-game number B is not zero (step S411: NO), the main CPU 41 controls the step to return to step S 403.

On the other hand, upon judging that the value of B is equal to zero (step S411: YES), the main CPU 41 terminates the free-game execution process.

FIG. 15 is a flowchart showing a subroutine of the jackpot bonus game execution process invoked and performed at step S210 of the subroutine shown in FIG. 12 and at step S407 of the subroutine shown in FIG. 14. At first, the main CPU 41 displays a first effect selection image (step S501). Specifically, the main CPU 41 displays the jackpot bonus game display image displaying the start of the jackpot bonus game on the upper image display panel 33, and a selection screen for determining the types of jackpot bonus games in the display region 92.

Next, the main CPU 41 judges whether or not the symbol is selected (step S502). Specifically, the main CPU 41 judges whether or not the symbol displayed on the selection screen for determining the types of jackpot bonus games is selected via the touch panel 69 or the like. Upon judging that the symbol is not selected (step S502: NO), the main CPU 41 controls the current step to return to the process at step S502.

On the other hand, upon judging that the symbol is selected (step S502: YES), the main CPU 41 displays the selected effect image (step S503). Specifically, the main CPU 41 sequentially reads out of the ROM 42, the effect image corresponding to the symbol selected at step S502, and displays the effect image on the display region 92.

Next, the main CPU 41 judges whether or not a “Win” effect is read (step S503). Specifically, the main CPU 41 judges whether or not the effect image read at step S503 corresponds to the “Win” effect. Upon judging that the read-out image does not correspond to the “Win” effect (step S504: NO), the main CPU 41 displays the effect image of “Lose” (step S505). Specifically, the main CPU 41 reads the effect image corresponding to the effect image of “Lose” from the ROM 42, and displays the effect image on the display region 92. Next, the main CPU 41 executes a payout process of “Mini” (step S506). Specifically, the main CPU 41 executes a coin-payout process corresponding to a “Mini” payout. Where the coins are deposited, the main CPU 41 executes a process for adding the number of paid-out coins to the credit amount stored in the RAM 43. On the other hand, in the coin-payout process, the main CPU 41 transmits the control signal to the hopper 66 to pay out the predetermined amount of coins. The main CPU 41 terminates the jackpot bonus game execution process when executing the process at step S606.

On the other hand, upon judging that the “Win” effect is read (step S504: YES), the main CPU 41 displays a second effect selection image (step S507). Specifically, the main CPU 41 displays on the display region 92 a selection screen for determining a type of the jackpot bonus game to be executed next.

Next, the main CPU 41 judges whether or not the predetermined symbol has been selected (step S508). Specifically, the main CPU 41 judges whether or not any one of symbols other than the symbol selected at step S502 is selected through the touch panel 69 or the like. Upon judging that the predetermined symbol is not selected (step S508: NO), the main CPU 41 controls the current step to return to the process at step S508.

On the other hand, upon judging that the predetermined symbol has been selected (step S508: YES), the main CPU 41 displays an effect image corresponding to the selected symbol (step S509). Specifically, the main CPU 41 sequentially reads out of the ROM 42 the effect image corresponding to the symbol selected at step S502, and displays the effect image on the display region 92.

Next, the main CPU 41 judges whether or not a “Win” effect is read (step S510). Specifically, the main CPU 41 judges whether or not the effect image read at step S509 corresponds to the “Win” effect. Upon judging that the read-out image does not correspond to the “Win” effect (step S510: NO), the main CPU 41 displays the effect image of “Lose” (step S511). Specifically, the main CPU 41 reads the effect image corresponding to the effect image of “Lose” from the ROM 42 and displays the effect image on the display region 92. Next, the main CPU 41 executes a payout process of “Major” (step S512). Specifically, the main CPU 41 executes a coin-payout process corresponding to a “Major” payout. Where the coins are deposited, the main CPU 41 executes a process for adding the number of paid-out coins to the credit amount stored in the RAM 43. On the other hand, in the coin-payout process, the main CPU 41 transmits the control signal to the hopper 66 to pay out the predetermined amount of coins. The main CPU 41 terminates the jackpot bonus game execution process when executing the process at step S512.

On the other hand, upon judging that the read-out image corresponds to the “Win” effect (step S510: YES), the main CPU 41 displays the effect image of “Win”. Specifically, the main CPU 41 reads the effect image corresponding to the effect image of “Win” from the ROM 42 and displays the effect image on the display region 92. Next, the main CPU 41 executes a payout process of “Mega” (step S514). Specifically, the main CPU 41 performs the coin-payout process corresponding to “Mega”. Where the coins are deposited, the main CPU 41 executes a process for adding the number of paid-out coins to the credit amount stored in the RAM 43. On the other hand, in the coin-payout process, the main CPU 41 transmits the control signal to the hopper 66 to pay out the predetermined amount of coins. The main CPU 41 terminates the jackpot bonus game execution process when executing the process at step S514.

Next, a slot machine 10 according to a second embodiment will be described in detail with reference to the drawings. The slot machine according to the second embodiment below has an appearance, a circuit configuration, and the like that are substantially the same as those of the slot machine 10 according to the first embodiment of the present invention. Thus, a duplicated explanation is omitted hereinafter. In addition, the constituent elements corresponding to those of the slot machine 10 are designated by the same reference numerals and are explained.

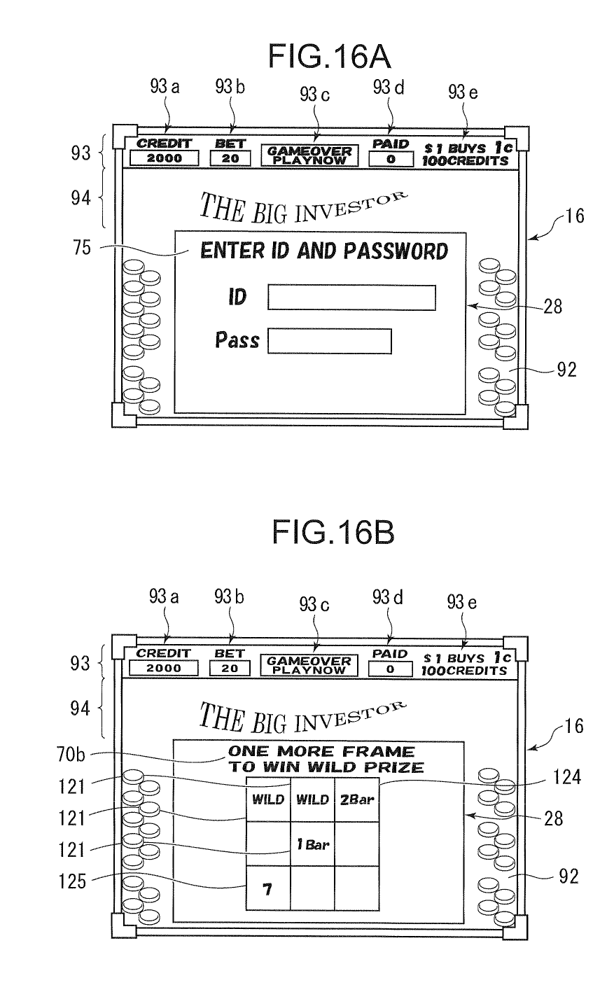

FIGS. 16A and 16B are views each showing an exemplary input image displayed in the slot machine shown in FIG. 2 according to the second embodiment of the present invention. As shown in FIG. 16A, the symbol display region 28 displays a screen through which a user ID and a password are entered. In this case, the symbol display region 28 displays an input screen 75 for displaying to a user, entry fields for the ID and the password.

As shown in FIG. 16B, any combination of the symbols “WILD” 121, “7” 122, “3Bar” 123, “2Bar” 124, “1Bar” 125, and “blank” 126 is rearranged in the symbol display region 28. In the case where the symbols displayed on the symbol display region 28 are arranged in the predetermined combination on the winning line, the payout is awarded. In the case where the combination is not a predetermined one, on condition that the user input the ID and the password, the remaining number of frames to form the predetermined combination is displayed. In this case, a combination of “WILD-WILD-2Bar” is rearranged on the winning line of the basic line BL, in which the rearranged symbols do not form the predetermined combination. Therefore, a remaining frame number display image 70b of “one more frame to win WILD prize” is displayed, which indicates that the reel needs scrolling down by one more frame to form the combination of “WILD-WILD-WILD”.

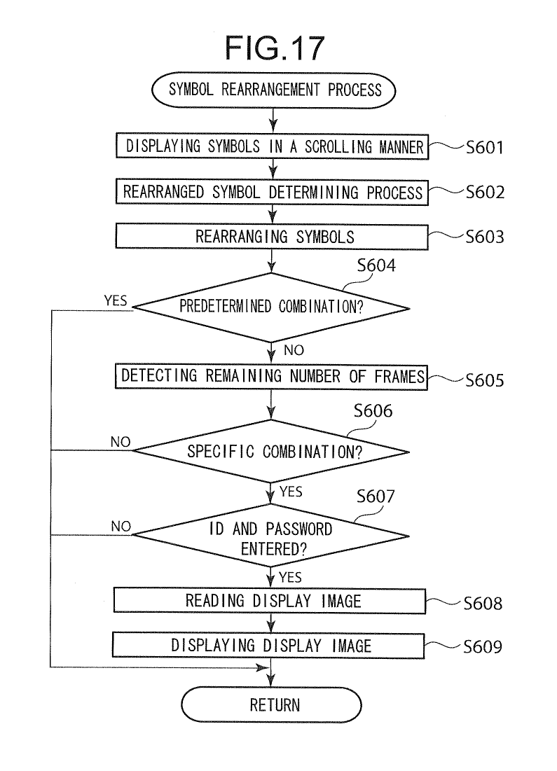

FIG. 17 is a flowchart showing a subroutine of the basic game symbol rearrangement process invoked and performed at step S204 of the subroutine shown in FIG. 12. First, the main CPU 41 displays the symbols in a scrolling manner (step S601). Specifically, the main CPU 41 starts rotation of the reels 102a to 102c. In this case, the six basic lines BL are set in the column and row directions, in the symbol display region 28. Further, the two cross lines CL are set in directions that obliquely cross the symbol display region 28.

The main CPU 41 then determines the symbols to be rearranged (step S602). Specifically, with respect to symbols rearranged in the symbol display area 28, the main CPU 41 executes a program stored in the RAM 43 to sample a random number value from a numerical value range of a predetermined random number value range. On the basis of the sampled random number value and symbol weighing data, from among the symbols, “WILD” 121, “7” 122, “3Bar” 123, “2Bar” 124, “1Bar” 125, and “blank” 126. The CPU 41 determines those to be rearranged in the symbol display area 28.

The main CPU 41 then rearranges the symbols (step S603). Specifically, the main CPU 41 stops rotation of the reels 102a to 102c so as to display, in a stopped state, the symbols determined at step S602, thereby rearranging the symbols.

Next, the main CPU 41 judges whether or not the combination is a predetermined one (step S604). Specifically, the main CPU 41 judges whether or not the symbols displayed on the symbol display region 28 are arranged in the predetermined combination allowed to award any of payouts. The main CPU 41 terminates the symbol rearrangement process upon judging that the combination is a predetermined one (step S604: YES).

On the other hand, upon judging that the combination is not a predetermined one (step S604: NO), the main CPU 41 detects the remaining number of frames (step S605). Specifically, the main CPU 41 detects the remaining number of frames to rearrange the symbols making up the winning combination on the winning line.

Next, the main CPU 41 judges whether or not the combination is a predetermined one (step S606). Specifically, the main CPU 41 judges whether or not any of combinations “WILD-WILD-18”, “WILD-WILD-19”, “WILD-WILD-20”, “WILD-WILD-01”, “WILD-WILD-02”, and “WILD-WILD-03” is formed (see FIG. 8). Upon judging that the combination is not a predetermined one (step S606: NO), the main CPU 41 terminates the symbol rearrangement process.

On the other hand, upon judging that the combination is a specific one (step 606: YES), the main CPU 41 judges whether or not the ID and the password are entered (step S607). Specifically, the main CPU 41 judges whether or not the user has entered the ID and the password, according to the screen displayed on the symbol display region 28, the screen through which the user enters the user ID and the password. Upon judging that the user has not yet entered the ID and the password (step S607: NO), the main CPU 41 terminates the symbol rearrangement process.

On the other hand, upon judging that the user has entered the ID and the password (step S607; YES), the main CPU 41 reads out the display image (step S608). Specifically, the main CPU 41 reads the display image data corresponding to the specific combination from among the plural types of display image data used for displaying the remaining number of frames to arrange the symbols in the predetermined combination, the symbols being displayed on the symbol display region 28.

The main CPU 41 then displays the display image (step S609). Specifically, the main CPU 41 displays the display image data read at step S307 on the lower image display panel 16. The main CPU 41 terminates the symbol rearrangement process when terminating this process.

The second embodiment of the present invention describes a case in which the remaining number of frames to arrange in the predetermined combination on the winning line, the symbols displayed on the symbol display region 28, on condition that the user enters the ID and the password. However, the present invention is not limitative thereto, and, for example, may be applicable to a structure in which control is exercised over a controller so as to display a probability that the game is shifted to the free game and the jackpot bonus game, in addition to the remaining number of frames, on condition that the user enters the ID and the password.

While the embodiment according to the present invention has been described, the description presents only some of the specific examples and is not intended to limit the present invention in any way and specific constructions of each means and the like can be properly changed in terms of design. Moreover, the effects described in the embodiment of the present invention are only the most preferable effects generated from the present invention and the effects to be caused by the present invention is not limitative thereto.

What is claimed is:

1. A slot machine, comprising:
a display device having a symbol display region for displaying plural types of symbols;
a memory for storing data relating to a plurality of display images used for displaying a remaining number of frames to arrange symbols displayed on the display region, in a predetermined combination on a winning line; and
a controller for controlling the display device and the memory, the controller being programmed to:
(a) execute a basic game;
(b) rearrange by displaying in a scrolling manner, the plural types of symbols in the symbol display region during the basic game;
(c) detect the remaining number of frames to rearrange the symbols making up a winning combination on the winning line at the time of the rearrangement of the itemized (b);
(d) award a payout in the case where the symbols displayed on the symbol display region are arranged in the predetermined combination on the winning line;
(e) read out of the memory, the data relating to the display image corresponding to the remaining number of frames detected in the itemized (c), in the case where the symbols displayed on the symbol display region are not arranged in the predetermined combination on the winning line; and
(f) display on a predetermined display region, the remaining number of frames to arrange the symbols displayed on the display region, in the predetermined combination on the winning line, based on the read data relating to the display image.

2. The slot machine according to claim 1, wherein:
the controller, in the itemized (e), reads out of the memory, the data relating to the display image corresponding to the remaining number of frames detected in the itemized (c), in the case where the combination is a specific combination from among the plural types of combinations, and then executes the itemized (f).

3. The slot machine according to claim 1 or 2, further comprising an input device for inputting a user ID, wherein:
the controller is programmed to:
(g) output based on the user ID input through the input device, a control signal for making a computer on a network authenticate the user ID; and
(h) receive from the computer on the network, a process signal corresponding to the control signal; and
the controller executes the processes itemized (c), (e), and (f) based on an authentication result of the user ID in accordance with the received process signal.

4. A slot machine, comprising:
a display device having a symbol display region for displaying plural types of symbols;
a memory for storing data relating to a plurality of display images used for displaying a remaining number of frames to arrange symbols displayed on the display region, in a predetermined combination on a winning line; and
a controller for controlling the display device and the memory, the controller being programmed to:
(a) execute a basic game;
(b) rearrange by displaying in a scrolling manner, the plural types of symbols in the symbol display region during the basic game;
(c) detect the remaining number of frames to rearrange the symbols making up a winning combination on the winning line at the time of the rearrangement of the itemized (b);
(d) award a payout in the case where the symbols displayed on the symbol display region are arranged in the predetermined combination on the winning line;
(e) read out of the memory, the data relating to the display image corresponding to the remaining number of frames detected in the itemized (c), in the case where the symbols displayed on the symbol display region are arranged in a specific combination from among plural types of combinations; and
(f) display on a predetermined display region, the remaining number of frames to arrange the symbols displayed on the display region, in the predetermined combination on the winning line, based on the read data relating to the display image.

5. The slot machine according to claim 4, further comprising an input device for inputting a user ID, wherein:
the controller is programmed to:
(g) output based on the user ID input through the input device, a control signal for making a computer on a network authenticate the user ID; and
(h) receive from the computer on the network, a process signal corresponding to the control signal; and
the controller executes the processes itemized (c), (e), and (f) based on an authentication result of the user ID in accordance with the received process signal.

6. A slot machine, comprising:
a display device having a symbol display region for displaying plural types of symbols;
a memory for storing data relating to a plurality of display images used for displaying a remaining number of frames to arrange symbols displayed on the display region, in a predetermined combination on a winning line;
a input device for inputting a user ID; and
a controller for controlling the display device, the memory, and the input device, the controller being programmed to:
(a) output based on the user ID input through the input device, a control signal for making a computer on a network authenticate the user ID; and
(b) receive from the computer on the network, a process signal corresponding to the control signal;
(c) execute a basic game;
(d) rearrange by displaying in a scrolling manner, the plural types of symbols in the symbol display region during the basic game;
(e) detect the remaining number of frames to rearrange the symbols making up a winning combination on the winning line, based on an authentication result of the user ID in accordance with the received process signal at the time of the rearrangement of the itemized (d);
(f) award a payout in the case where the symbols displayed on the symbol display region are arranged in the predetermined combination on the winning line;
(g) read out of the memory, the data relating to the display image corresponding to the remaining number of frames detected in the itemized (e) based on the authentication result of the user ID in accordance with the received process signal, in the case where the symbols displayed on the symbol display region are arranged in a specific combination from among the plural types of combinations; and
(h) display on a predetermined display region, the remaining number of frames to arrange the symbols displayed on the display region, in the predetermined combination on the winning line, based on the read data relating to the display image, based on the authentication result of the user ID in accordance with the received process signal.
